(19) United States
(12) Patent Application Publication
(10) Pub. No.: US 2009/0109060 A1
(43) Pub. Date: Apr. 30, 2009

(54) Optical-film traffic sign

(75) Inventors: Yu-Nan Liu, Taichung County (TW); Yi-Wen Lin, Taichung County (TW); Hui-Ying Chiang, Taichung County (TW); Tai-Lung Chang, Taichung County (TW); Chun-Fang Hsieh, Taichung County (TW); Jing-Nuan Lai, Taichung County (TW); Shou-Chang Yeh, Taichung County (TW)

Correspondence Address: Joe McKinney Muncy, PO Box 1364, Fairfax, VA, 22038-1364, US

(73) Assignee: PONTEX POLYBLEND CO., LTD.

(21) Appl. No.: 11/979,052

(22) Filed: Oct. 30, 2007

(51) Int. Cl. G08G 1/095

(52) U.S. Cl. 340/907

(57) ABSTRACT

The present invention discloses an optical-film traffic sign, which comprises: a light-guide element, an optical film and at least one light source. A plurality of diffusion dots is printed on the light-guide element. The light from the light source is repeatedly scattered by the diffusion dots. Thereby, the light-guide element becomes a highly uniform planar light source. The optical film having a traffic sign is applied onto the surface of the light-guide element to form a slim and uniformly-luminous traffic sign. The present invention may adopt LED as the light source and thus has the advantage of energy saving.

### FIELD OF THE INVENTION

The present invention relates to a traffic sign, particularly to a slim, uniformly-luminous and energy conservation traffic sign.

### BACKGROUND OF THE INVENTION

Traffic signs provide important traffic information for drivers. For the visibility at night, self-luminous traffic signs have been gradually adopted now.

Refer to FIG. 1 for a conventional self-luminous traffic sign. The conventional self-luminous traffic sign includes: a casing 1 made of a plastic material, such as an acrylic material, and having a traffic sign 3 on the surface thereof; and a light-emitting element arranged inside the casing 1, such as a fluorescent lamp 2. The light emitted by the fluorescent lamp 2 together with the traffic sign 3 realizes a self-luminous traffic sign.

The casing 1 of the conventional self-luminous traffic sign needs a considerable thickness so that there will be a sufficient room to accommodate the fluorescent lamp 2. Thus, the casing 1 is heavy and bulky. When the conventional self-luminous traffic sign is installed beside the road, drivers' eyesight will be impaired. Besides, the heavy and bulky conventional self-luminous traffic sign is easy to drop and break. Further, the illumination of the fluorescent lamp 2 is of insufficient uniformity, which influences the perception of drivers. To solve such a problem, more fluorescent lamps should be used, which will consume a great amount of power.

### SUMMARY OF THE INVENTION

The primary objective of the present invention is to provide a slim, uniformly-luminous and energy-efficient traffic sign, which can reduce cost and increase drivers' eyesight.

The present invention proposes an optical-film traffic sign, which comprises: a light-guide element, an optical film and at least one light source. The light-guide element has a plurality of diffusion dots printed thereon. The light-guide element closely contacts the light source and receives light from the light source. The optical film is applied onto the light-guide element, and a traffic sign adheres to the external surface of the optical film.

The light-guide element, which can function as a planar light source, together with the traffic sign on the optical film, forms a self-luminous traffic sign. Compared with the conventional traffic signs, the optical-film traffic sign of the present invention has the advantages of uniform luminosity, slimness, lightweight, and energy efficiency. Further, the present invention can reduce the cost of fabrication and application, increase the visibility of a traffic sign and promote the eyesight of drivers.

### BRIEF DESCRIPTION OF THE DRAWINGS

FIG. 1 is a diagram showing the structure of a conventional self-luminous traffic sign.

FIG. 2A is a perspective view schematically showing an optical-film traffic sign of the present invention.

FIG. 2B is a sectional view along line 2B-2B in FIG. 2A.

FIG. 3 is a sectional view schematically showing another embodiment of the present invention.

FIG. 4 is a sectional view schematically showing a light-guide element in another embodiment of the present invention.

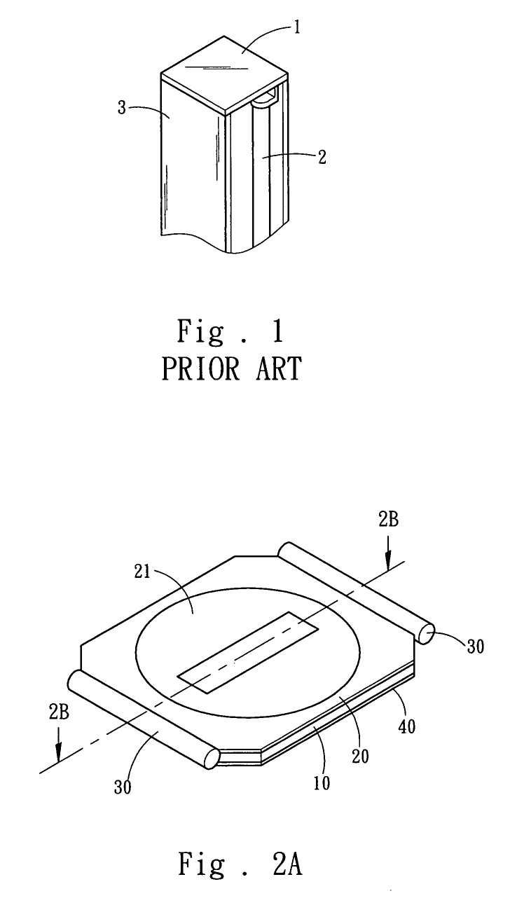

### DETAILED DESCRIPTION OF THE PREFERRED EMBODIMENTS

Below, a preferred embodiment will be described in cooperation with the drawings to make easily understood the objectives, characteristics and efficacies of the present invention.

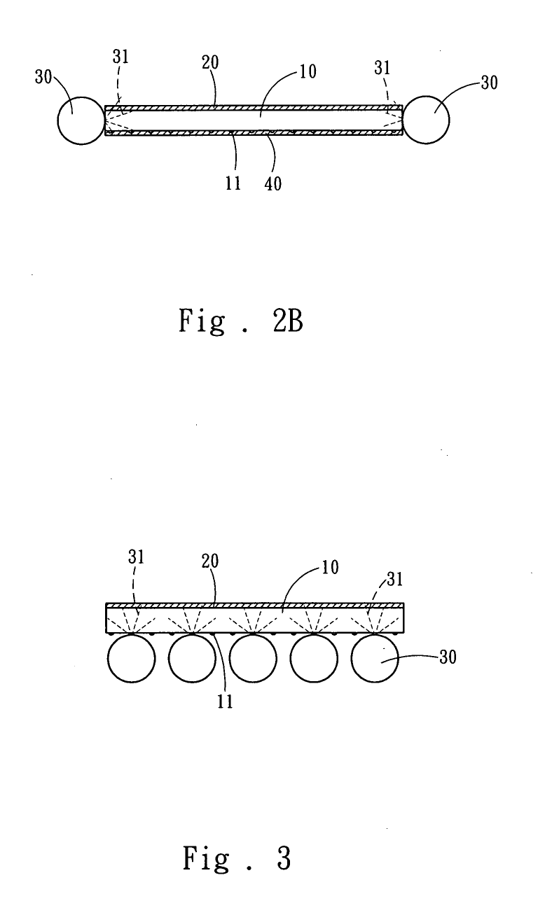

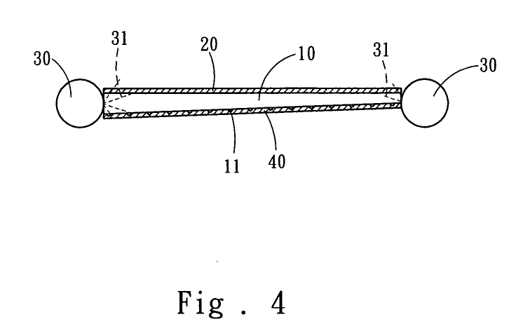

Refer to FIG. 2A and FIG. 2B. The optical-film traffic sign of the present invention comprises: a light-guide element 10, an optical film 20 and at least one light source 30. A plurality of diffusion dots 11 is printed on the light-guide element 10. The light source 30 may be LED (Light Emitting Diode) or CCFL (Cold Cathode Fluorescent Lamp). The light-guide element 10 may be a planar plate or a tapered plate (as shown in FIG. 4). The light source 30 is arranged in the border of the light-guide element 10 and closely contacts the light-guide element 10. Thus, the light 31 emitted by the light source 30 enters the light-guide element 10.

The light 31 from the light source 30 is repeatedly scattered by the diffusion dots 11. Thereby, the light-guide element 10 becomes a highly uniform planar light source. The optical film 20 is closely applied onto the external surface of the light-guide element 10. The optical film 20 has a traffic sign 21 on the surface thereof. The traffic sign 21 may be any symbol having a specified meaning, such as turn right, warning, a road name, etc. The traffic sign 21 may be printed on or stuck onto the optical film 20. Besides, a reflective film 40 may be arranged on the bottom of the light-guide element 10, and the reflective film 40 will reflect the light 31 of the light source 30 to leave from the optical film 20.

Refer to FIG. 3 for another embodiment of the present invention. In this embodiment, the light-guide element 10 is a planar plate, and the light sources 30 are arranged below the light-guide element 10. In such an arrangement, the light of the light sources 30 can also enter the light-guide element 10 normally. The optical film 20 can be stuck onto and removed from the light-guide element 10 repeatedly. Therefore, the traffic sign 21 can be updated according to physical traffic requirement.

In the present invention, light 31 enters the light-guide element 10 and is scattered by the diffusion dots 11. Thereby, the light-guide element 10 becomes a highly uniform planar light source. The present invention can increase the visibility of traffic signs and can easily realize the slimming of traffic signs. As the light source 30 may adopt LED, the present invention is energy-efficient. Besides, the present invention can reduce cost and increase drivers' eyesight.

What is claimed is:

1. An optical-film traffic sign comprising:
a light-guide element having a plurality of diffusion dots printed thereon;
a light source closely contacting said light-guide element and emitting light entering said light-guide element; and
an optical film closely applied onto the external surface of said light-guide element and having a traffic sign on the external surface thereof.

2. The optical-film traffic sign according to claim 1, wherein said traffic sign is printed on said optical film.

3. The optical-film traffic sign according to claim 1, wherein said traffic sign is stuck onto said optical film.

4. The optical-film traffic sign according to claim 1, wherein said light source may be LED (Light Emitting Diode) or CCFL (Cold Cathode Fluorescent Lamp).

5. The optical-film traffic sign according to claim 1, wherein said light-guide element is a planar plate, and said light source is arranged in a border of said light-guide element.

6. The optical-film traffic sign according to claim 5, wherein a reflective film is arranged on the bottom of said light-guide element.

7. The optical-film traffic sign according to claim 1, wherein said light-guide element is a planar plate, and said light source is arranged below said light-guide element.

8. The optical-film traffic sign according to claim 1, wherein said light-guide element is a tapered plate.

9. The optical-film traffic sign according to claim 1, wherein said optical film can be stuck onto and removed from the surface of said light-guide element repeatedly.
